(19) United States
(12) Patent Application Publication
(10) Pub. No.: US 2007/0063366 A1
(43) Pub. Date: Mar. 22, 2007

(54) Removal of fluid by-product from a solid deposition modeling process

(75) Inventors: Stephen M. Cunningham, San Marcos, CA (US); Thomas O'Regan, San Diego, CA (US); John Stockwell, Sylmar, CA (US)

Correspondence Address: SUMMA, ALLAN & ADDITON, 11610 N. COMMUNITY HOUSE ROAD, SUITE 200, CHARLOTTE, NC, 28277, US

(73) Assignee: 3D Systems, Inc., Valencia, CA (US)

(21) Appl. No.: 11/230,030

(22) Filed: Sep. 19, 2005

(51) Int. Cl. B29C 35/08

(52) U.S. Cl. 264/37.1; 264/113; 425/174.4

(57) ABSTRACT

A by-product waste material removal system for solid deposition modeling. As excess build and support material is removed during the build as a by-product waste the removal system collects the by-product waste material into a waste receptacle for disposal. The by-product waste material removal system requires no mechanical systems.

### BACKGROUND OF THE INVENTION

1. Field of the Invention

The invention relates in general to a system and a method for reliably collecting for removal the by-product waste stream generated from a solid deposition modeling process. In addition, the system can be integrated with a sealed waste removal system wherein reactive materials can be employed without special handling procedures.

2. Description of the Prior Art

Recently, several new technologies have been developed for the rapid creation of models, prototypes, and parts for limited run manufacturing. These new technologies can generally be described as solid freeform fabrication, herein referred to as “SFF”. Some SFF techniques include stereolithography, selective deposition modeling, laminated object manufacturing, selective phase area deposition, multi-phase jet solidification, ballistic particle manufacturing, fused deposition modeling, particle deposition, laser sintering, and the like. In SFF, complex parts are produced from a modeling material in an additive fashion as opposed to conventional fabrication techniques, which are generally subtractive in nature. For example, in conventional fabrication techniques material is removed by machining operations or shaped in a die or mold to near net shape and then trimmed. In contrast, additive fabrication techniques incrementally add portions of a build material to targeted locations, typically layer by layer, in order to build a complex part.

SFF technologies typically utilize a computer graphic representation of a part and a supply of a build material to fabricate the part in successive layers. SFF technologies have many advantages over the prior conventional manufacturing methods. For instance, SFF technologies dramatically shorten the time to develop prototype parts and can quickly produce limited numbers of parts in rapid manufacturing processes. They also eliminate the need for complex tooling and machining associated with the prior conventional manufacturing methods, particularly when creating molds for casting operations. In addition, SFF technologies are advantageous because customized objects can be produced quickly by processing computer graphic data.

There are a wide variety of build materials that are used in various SFF techniques. These materials are typically applied in the form of a powder, liquid, gas, paste, foam, or gel. Recently, there has developed an interest in utilizing highly viscous paste materials in SFF processes to achieve greater mechanical properties. In addition, an interest has recently developed in reproducing visual features such as color on the three-dimensional objects produced by SFF processes. This has produced a need to develop special additives for the build materials along with new dispensing systems to enable the production of these visual features when building the three-dimensional objects.

One category of SFF that has emerged is selective deposition modeling, herein referred to as “SDM”. In SDM, a build material is physically deposited in a layerwise fashion while in a flowable state and is allowed to solidify to form an object. In one type of SDM technology the modeling material is extruded as a continuous filament through a resistively heated nozzle. In yet another type of SDM technology the modeling material is jetted or dropped in discrete droplets in order to build up a part. In one particular SDM apparatus, a thermoplastic material having a low-melting point is used as the solid modeling material, which is delivered through a jetting system such as those used in ink jet printers. One type of SDM process utilizing ink jet print heads is described, for example, in U.S. Pat. No. 5,555,176 to Menhenneft, et al.

Because ink jet print heads are designed for use in two-dimensional printing, special modifications must be made in order to use them in building three-dimensional objects by SFF techniques. This is generally because there are substantial differences between the two processes, thus requiring different solutions to different problems. For example, in two-dimensional printing a relatively small amount of an ink is jetted and allowed to dry or solidify with a significant interest being given to print resolution. Because only a small amount of material is jetted in two-dimensional printing, the material reservoir for the liquid material can reside directly in the ink jet print head while providing the ability to print numerous pages before needing to be refilled or replaced. In contrast, in SDM utilizing an ink jet printhead, a large amount of normally solid material, such as a thermoplastic or wax material, must be heated to a flowable state, jetted, and then allowed to solidify. Furthermore, in SDM dispensing resolution is not as critical as it is in two-dimensional printing. This is generally because, for each targeted pixel location, the amount of material to be jetted in SDM techniques is substantially greater than the amount to be jetted in two-dimensional printing techniques. For example, it may be required to deposit six droplets on a particular pixel location in SDM compared to just one or two droplets in two-dimensional printing. Although the targeting accuracy may be the same, the actual resolution achieved in SDM techniques is generally somewhat less than in two-dimensional printing because the six droplets dispensed may droop or slide towards adjacent pixel locations.

The differences mentioned above are significant and create a number of problems to be resolved. For instance, the amount of material deposited in ink jet based SDM techniques, both in volume and in mass, can be so substantial that it is generally considered impractical to mount a reservoir directly on the ink jet print head to hold all of the material. Thus, it is typical in most SDM systems to provide a large reservoir at a location remote from the print head that is in communication with the ink print head via a material delivery system having a flexible umbilical tube. However, the large container and umbilical tube must be heated to cause at least some of the build material to become or remain flowable so that the material can flow to the dispensing device. Start up times are longer for SDM techniques using ink jet print heads than in two-dimensional printing with ink jet print heads due to the length of time necessary to initially heat the solidified material in the large remote reservoir to its flowable state. In addition, a significant amount of energy is required to maintain the large quantity of material in the flowable state in the reservoir and in the delivery system during the build process. This generates a significant amount of heat in the build environment.

Another problem that is unique to SDM techniques is that the layers being formed must be shaped or smoothed during the build process to establish a uniform layer thickness. Normalizing the layers is commonly accomplished with a planarizer that removes a portion of the material dispensed in the layers. One such planarizer is disclosed in U.S. Pat. No. 6,270,335 to Leyden et al. However, the planarizer produces waste material during the build process that must be handled. This is less of a concern when working with non-reactive materials; however, it is a greater concern when reactive materials are used. For example, most photopolymers are reactive, and excessive contact to human skin may result in sensitivity reactions. Thus, most SFF processes that utilize photopolymer materials require some additional handling procedures in order to minimize or eliminate excessive physical contact with the materials. For example, in stereolithography, operators typically wear gloves when handling the liquid resin and when removing finished parts from the build platform. However, SDM operators who normally handle even non-reactive materials consider additional handling procedures inconvenient and, if possible, would prefer they be eliminated. For reactive materials in SDM systems the issue is compounded and rises above mere inconvenience. Thus, there is a need to provide a material feed and waste system for SDM that can handle reactive materials without requiring the implementation of special handling procedures.

A by-product waste handling system for dealing with the aforementioned waste stream from an SDM process is described in US patent application publication 2005/0017393 A1, entitled “Accumulation, control, and accounting of fluid by-product from a solid deposition modeling process” and assigned to the assignee of the present invention. In that system excess build and support material is removed during the build as a by-product waste and the removal system accumulates, measures, and releases the by-product waste material into a waste receptacle for disposal. Although workable, that system is significantly simplified by the instant invention.

These and other difficulties of the prior art are overcome according to the present invention by providing a new and simpler by-product waste removal system for a solid deposition modeling system.

### BRIEF SUMMARY OF THE INVENTION

The instant invention provides its benefits across any SFF process that requires removal of excess build and/or support material during a build. This is done by providing a reliable and lower cost system for removing by-product waste material from a SFF device for forming three-dimensional objects.

It is one aspect of the instant invention to provide an improved by-product waste removal system for SFF systems that overcomes the earlier mentioned disadvantages of prior art systems.

It is another aspect of the instant invention to provide an improved by-product waste removal system for SFF systems that does not require a mechanical transfer system.

It is an advantage that the by-product waste removal system of the present invention is lower in cost, simpler and more effective than prior by-product waste removal systems.

These and other aspects, features and advantages are provided by a method for delivering at least one material and removing waste material in a solid freeform fabrication apparatus to form a three-dimensional object, the method including at least the steps of: delivering material to a dispensing device; dispensing the removed material from the dispensing device in a layerwise fashion to form the three-dimensional object; producing waste material from the dispensed material and depositing the waste material in a waste receptacle, wherein the depositing step comprises flowing the waste material through a heated line to a heated nozzle; releasing the waste material from the heated nozzle to the waste receptacle; and heating the waste material in the receptacle until the three-dimensional object is formed.

The invention also includes a material feed and waste system for a solid freeform fabrication apparatus, the system including at least a means for delivering at least one material to at least one dispensing device; a means for dispensing the discrete amount of material by the dispensing device in a layerwise fashion to form via a plurality of layers a three-dimensional object; a means for normalizing the layers of the three-dimensional object wherein waste material is produced; means for depositing the waste material in a waste receptacle; wherein the means for depositing the waste material comprises: means for flowing the waste material through a heated line to a heated nozzle; means for releasing the waste material from the heated nozzle to the waste receptacle; and means for heating the waste material in the receptacle until the three-dimensional object is formed.

These and other aspects, features, and advantages are achieved according to the method and apparatus of the present invention that employs a unique fluid by-product removal system that automatically and reliably transfers measured amounts of fluid by-product waste material to a final collection container.

### BRIEF DESCRIPTION OF THE DRAWINGS

These and other aspects, features and advantages of the present invention method and apparatus will become apparent upon consideration of the following detailed disclosure of the invention, especially when it is taken in conjunction with the accompanying drawings wherein:

FIG. 1 is a schematic view of a prior art SDM apparatus and the by-product waste removal scheme;

FIG. 2 is a perspective view of a SDM apparatus of the embodiment shown schematically in FIG. 1; and

FIG. 3 is a schematic view of a preferred embodiment of the fluid by-product waste removal scheme of the instant invention.

### DETAILED DESCRIPTION OF THE PREFERRED EMBODIMENTS

The present invention provides its benefits across a broad spectrum of SFF processes. While the description which follows hereinafter is meant to be representative of a number of such applications, it is not exhaustive. As will be understood, the basic apparatus and methods taught herein can be readily adapted to many uses. It is intended that this specification and the claims appended hereto be accorded a breadth in keeping with the scope and spirit of the invention being disclosed despite what might appear to be limiting language imposed by the requirements of referring to the specific examples disclosed.

While the present invention can be applicable to other SFF techniques and objects made therefrom, the invention will be described with respect to solid deposition modeling (SDM) utilizing a build material dispensed in a flowable state. However it is to be appreciated that the present invention can be implemented with any SFF technique that requires the continuous or intermittent removal of by-product waste during a build. For example, the build material can be a photocurable or sinterable liquid or powder material that is heated to a flowable state but when solidified may form a high viscosity liquid, a semi-solid, a gel, a paste, or a solid. In addition, the build material may be a composite mixture of components, such as a mixture of photocurable liquid resin and powder material such as metallic, ceramic, or mineral, if desired.

As used herein, the term “a flowable state” of a build material is a state wherein the material is unable to resist shear stresses that are induced by a dispensing device, such as those induced by an ink jet print head when dispensing the material, causing the material to move or flow. Preferably the flowable state of the build material is a liquid state, however the flowable state of the build material may also exhibit thixotropic properties. The term “solidified” and “solidifiable” as used herein refer to the phase change characteristics of a material where the material transitions from the flowable state to a non-flowable state. A “non-flowable state” of a build material, as used herein, is a state wherein the material is sufficiently self-supportive under its own weight so as to hold its own shape. Build materials existing in a solid state, a gel state, a paste state, or a thixotropic state are examples of a non-flowable state of a build material for the purposes of discussion herein. Further, the term “cured” or “curable” refers to any polymerization reaction. Preferably the polymerization reaction is triggered by exposure to radiation or thermal energy.

Most preferably the polymerization reaction involves the cross-linking of monomers and oligomers initiated by exposure to actinic radiation in the ultraviolet or infrared wavelength band. Further, the term “cured state” refers to a material, or portion of a material, in which the polymerization reaction has substantially completed. It is to be appreciated that as a general matter the material can easily transition between the flowable and non-flowable state prior to being cured. However, once cured, the material cannot transition back to a flowable state and be dispensed by the apparatus.

Additionally, the term “support material” refers to any material that is intended to be dispensed to form a support structure for the three-dimensional objects as they are being formed, and the term “build material” refers to any material that is intended to be dispensed to form the three-dimensional objects. The build material and the support material may be similar materials having similar formulations but, for purposes herein, they are to be distinguished only by their intended use.

A preferred method for dispensing a curable phase change material to form a three-dimensional object and for dispensing a non-curable phase change material to form supports for the object is disclosed in U.S. Pat. No. 6,841,116 entitled “Selective Deposition Modeling with Curable Phase Change Materials”, assigned to the assignee of the present invention. A preferred curable phase change material and non-curable phase change support material are disclosed in U.S. Pat. No. 6,841,589 entitled “Ultra-Violet Light Curable Hot Melt Composition”, also assigned to the assignee of the present invention. An SDM system and method using powder is disclosed in U.S. Pat. No. 6,416,850 and a method of using an ink jet printhead to deliver a binder to layers of powdered material is described in U.S. Pat. No. 5,204,055.

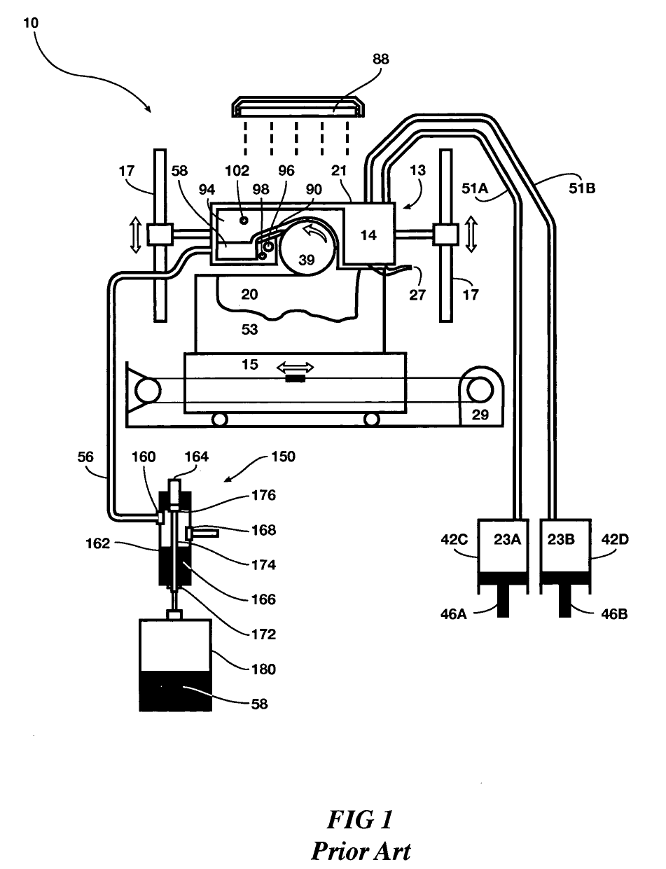

Referring particularly to FIG. 1 there is illustrated generally by the numeral 10 a prior art solid freeform fabrication apparatus of the SDM type that can be adapted to incorporate the waste removal system of the instant invention. This apparatus 10 is schematically shown including a material feed and waste system indicated generally by the numeral 13. The build platform 15 is reciprocally driven by conventional drive means 29. The dispensing trolley 21 is precisely moved by actuation means 17 vertically to control the thickness of the layers of the object 20. The actuation means 17 comprises precision lead screw linear actuators driven by servomotors. The ends of the linear actuators 17 reside on opposite ends of the build environment 13 and in a transverse direction to the direction of reciprocation of the build platform. However, for ease of illustration in FIG. 1 they are shown in a two-dimensionally flat manner giving the appearance that the linear actuators are aligned in the direction of reciprocation of the build platform 15. Although they may be aligned with the direction of reciprocation, it is sometimes preferred they be situated in a transverse direction so as to optimize the use of space within the apparatus.

In the build environment illustrated generally by numeral 13 in FIG. 1, there is shown by numeral 20 a three-dimensional object being formed with integrally formed supports 53. The object 20 and supports 53 both reside in a sufficiently fixed manner on the build platform 15 so as to sustain the acceleration and deceleration effects during reciprocation of the build platform 15 while still being removable from the platform. In order to achieve this, it is desirable to dispense at least one complete layer of support material on the build platform 15 before dispensing the build material since the support material is designed to be removed at the end of the build process. In this embodiment, the build material identified by numeral 23A is dispensed by the dispensing device 14 that is in fluid flow communication with the material feed portion of system 13 to form the three-dimensional object 20. The support material, identified by numeral 23B, is dispensed in the same manner by dispensing device 14 to form the supports 53. Containers identified generally by numerals 42C and 42D, respectively hold a discrete amount of these two materials 23A and 23B. Umbilicals 51A and 51B, respectively deliver the material to dispensing device 14, which in the preferred embodiment is an ink jet print head having a plurality of dispensing orifices 27.

Preferably the materials 23A and 23B of FIG. 1 are phase change materials that are heated to a liquid state, and heaters (not shown) are provided on the umbilicals 51A and 51B to maintain the materials in a flowable state as they are delivered to the dispensing device 14. In this embodiment the ink jet print head 14 is configured to dispense both materials from a plurality of dispensing orifices 27 so that both materials can be selectively dispensed in a layerwise fashion to any location in any layer being formed. When the dispensing device 14 needs additional material 23A or 23B, pistons 46A and 46B, respectively are engaged to extrude the material from the containers 42C and 42D, through the umbilicals 51A and 52B, and to discharge orifices 27 of the dispensing device 14.

The dispensing trolley 21 in the embodiment shown in FIG. 1 includes a heated planarizer 39 that removes excess material 23A and 23B from the layers being dispensed to normalize the dispensed layers. The heated planarizer 39 contacts the build and support materials 23A and 23B in their non-flowable state and, because it is heated, locally transforms some of the materials to a flowable state. Due to the forces of surface tension, the excess flowable materials 23A and 23B adhere to the surface of the planarizer 39, and as the planarizer 39 rotates the adhered materials are brought up to the skive 90 which is in contact with the planarizer 39. The skive 90 separates the excess materials 23A and 23B that are now waste material from the surface of the planarizer 39 and directs the flowable material into a waste reservoir, identified generally by numeral 94 located on the trolley 21. A heater 96 and thermistor 98 on the waste reservoir 94 operate to maintain the temperature of the waste reservoir at a sufficient level so that the waste material 58 in reservoir 94 remains in a flowable state.

Beginning with the waste umbilical tube or line 56 in FIG. 1, the by-product waste material removal system of the prior art is shown generally by the numeral 150 and will be described hereafter as accumulator 150. By-product waste material 58 from the waste reservoir 94 flows by gravity through line 56 and into intermediate vessel or holding tank 162 of accumulator 150 through inlet line 160. Vessel 162 is a tank that has sealable openings at the base or bottom and the top with o-ring seals that open and close when actuator 164 moves a central rod 174 up or down. When rod 174 is moved to the up position, top vent 176 is opened to the atmosphere and base drain 172 is sealed to allow vessel 162 of accumulator 150 to fill with by-product waste. A level detector 168 senses when the level of by-product waste material 166 rises to the level detector. Level detector 168 then activates actuator 164 to move central rod 174 down; closing top vent 176 and opening base drain 172. When drain 172 opens the by-product waste material 58 rapidly empties through drain 172 by gravity flow into waste material receptacle 180. Because top vent 176 is closed at this time the flow of liquid waste creates a slight negative pressure, effectively pulling any residual by-product waste material 58 from line 56.

After vessel 162 empties actuator 164 is activated to move central rod 174 up, closing the bottom seal 172 and opening top vent 176 to vent to the atmosphere to thereby allow vessel 162 to begin refilling for the next cycle.

In the prior art system of FIG. 1, an additional detection system is provided in the waste system to prevent the waste material 58 from overflowing the waste reservoir 94. The system comprises an optic sensor 102 provided in the waste reservoir 94 that detects an excess level of waste material 58 in the reservoir 94. If the level of the waste material 58 in the waste reservoir 94 raises above a set level, it is detected by the sensor 102. The sensor 102 in turn provides a signal to a computer controller (not shown), which shuts down the apparatus. This prevents waste material from flooding the components inside the apparatus 10 in the event of a malfunction of the feed and waste system 86. The apparatus 10 can then be serviced to correct the malfunction, thus preventing excessive damage to the apparatus.

In the prior art system shown in FIG. 1, the build material 23A is a phase change material that is cured by exposure to actinic radiation. After the curable phase change material 23A is dispensed in a layer it transitions from the flowable state to a non-flowable state. After a layer has been normalized by the passage of the planarizer 39 over the layer, the layer is then exposed to actinic radiation by radiation source 88 to cure the build material 23A. Preferably the actinic radiation is in the ultraviolet or infrared band of the spectrum. It is important, however, that planarizing occurs prior to exposing a layer to the radiation source 88. This is because the preferred planarizer can only normalize the layers if the material in the layers can be changed from the non-flowable to the flowable state. This cannot occur if the material 23A is first cured.

In conjunction with the curable build material 23A, a non-curable phase change material is used for the support material 23B. Since the support material 23B cannot be cured, it can be removed from the object and build platform, for example, by being dissolved in a solvent. Alternatively the support material 23B can be removed by application of heat to return the material to a flowable state, if desired.

In this prior art system the by-product waste material 58 comprises both materials 23A and 23B as they accumulate during planarizing.

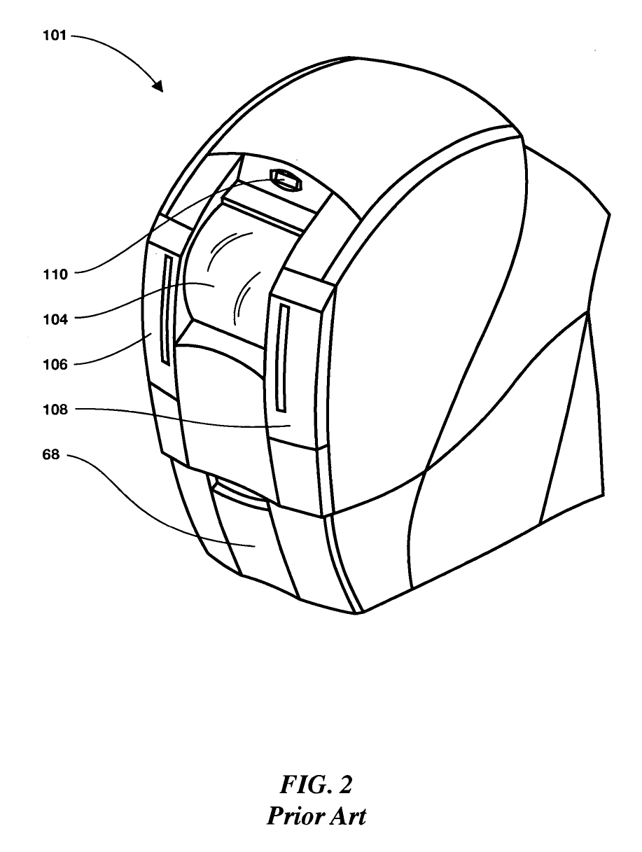

Now referring to FIG. 2, the SDM apparatus schematically shown in FIG. 1 is shown perspectively as 101. To access the build environment, a slideable or retractable door 104 is provided at the front of the apparatus. The door 104 does not allow radiation within the machine to escape into the outside environment. The apparatus is configured such that it will not operate or turn on with the door 104 open. In addition, when the apparatus 10 is in operation the door 104 will not open. A support material feed door 106 is provided so that the support material containers (not shown) can be inserted into the apparatus 10. A build material feed door 108 is also provided so that the build material containers (not shown) can be inserted into the apparatus. A waste drawer 68 is provided at the bottom end of the apparatus 10 so that expelled waste containers can be removed from the apparatus 10. A user interface 110 is provided which is in communication with an internal computer (also not shown), which tracks receipt of the print command data from an external computer. That typically is the user's workstation computer or a computer network.

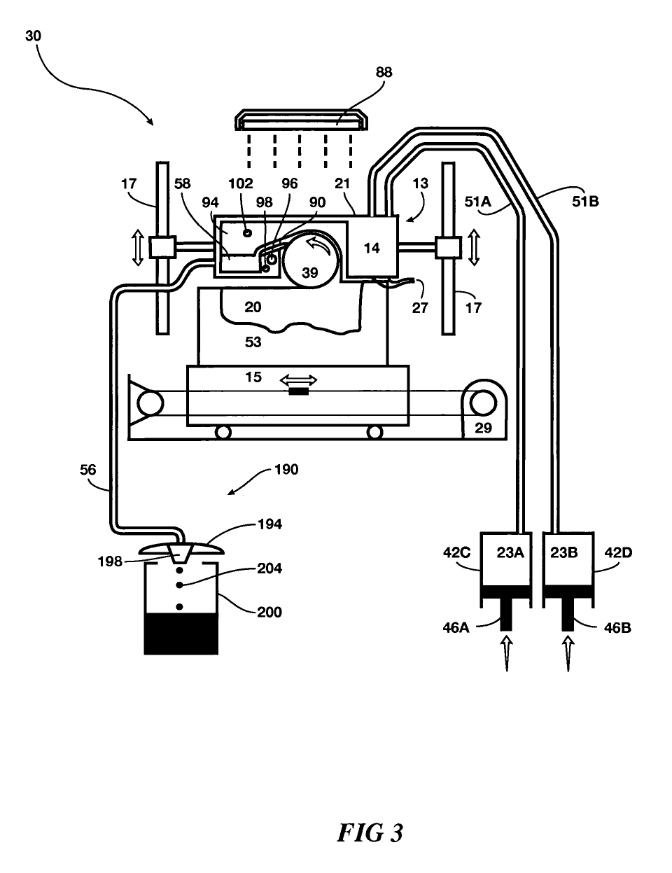

Turning to FIG. 3, a schematic of a similar SDM device is shown generally by the numeral 30 but with the by-product waste removal system 150 replaced by the by-product removal system of the present invention.

In FIG. 3 the complete build apparatus of the SDM device operates as described in FIG. 1 in building parts. Therefore that aspect of the description of the method and apparatus will not be repeated here, but it will be understood to be the same as the description given with respect to FIG. 1. In addition the schematic shown in FIG. 3 operates within the same industrial design shown in the perspective view of FIG. 2.

Beginning with the waste umbilical tube or line 56 in FIG. 3, the by-product waste material removal system of the instant invention is shown generally by the numeral 190. By-product waste material 58 from the waste reservoir 94 flows by gravity through line 56 and eventually into waste material receptacle 200.

Waste material receptacle 200, in a preferred embodiment, is a disposable polypropylene bag with a zipper closure that can be easily removed for disposal. It should be recognized that the use of a polypropylene bag is only one embodiment and that other bags or bottles may be employed in the instant invention.

In another embodiment (not shown) a source of actinic radiation could be mounted near waste receptacle 200 to cure the by-product waste material in waste receptacle 200.

In operation the instant invention operates as follows. Referring to FIG. 3, once a SDM build is in progress waste material 58 is generated and flows from the waste reservoir 94 down line 56 by gravity. Reliable operation requires that the material flows completely into waste receptacle 200 and does not freeze prematurely. Line 56 is thus a heated line and may be a heated umbilical. Line 56 is connected to a heated nozzle 198 that feeds material 204 directly by gravity into waste receptacle 200. By product waste material can drip continuously into waste receptacle 200 where it can collect.

To avoid freezing material collecting on the top of waste receptacle 200 or forming an uneven mound of solidified material in a “stalagmite” or mound-like fashion in the receptacle 200, a heater 194 is positioned either adjacent to or around heated nozzle 198. Heated nozzle 198 and heater 194 are positioned directly above waste receptacle 200. A preferred heater 194 is a ceramic infrared radiant heater. It has also been found that reliable operation with lower energy consumption can be achieved if radiant heater 194 is operated periodically or intermittently rather than full time during a build. Radiant heater ensures the waste material 204 accumulates in a generally flat or even fashion in waste receptacle 200. When waste receptacle 200 is full, or at any desired time prior to commencing a build, the waste material 204 is allowed to solidify or gel and the receptacle 200 is removed from the device 30, discarded and replaced with an empty receptacle.

The resulting waste collection system described above has been found to be fully reliable, simpler in operation, and lower in cost than prior art solutions.

While the invention has been described above with references to specific embodiments thereof, it is apparent that many changes, modifications and variations in the materials, arrangements of parts and steps can be made without departing form the inventive concept disclosed herein. Accordingly, the spirit and broad scope of the appended claims is intended to embrace all such changes, modifications and variations that may occur to one of skill in the art upon a reading of the disclosure. All patent applications, patents and other publications cited herein are incorporated by reference in their entirety.

1. A method for delivering at least a build material and removing waste material in solid freeform fabrication apparatus to form a three-dimensional object, the method comprising the steps of:
delivering build material to a dispensing device;
dispensing said build material from said dispensing device in a layerwise fashion to form the three-dimensional object;
producing waste material from said dispensed material;
depositing said waste material in a waste receptacle, wherein said depositing step comprises:
a) flowing said waste material through a heated line to a heated nozzle;
b) releasing said waste material from said heated nozzle to said waste receptacle; and
c) heating said waste material in the waste receptacle until a three-dimensional object is formed.

2. The method according to claim 1 further comprising the step of curing said waste material in said waste receptacle by exposing said waste material to actinic radiation.

3. The method according to according to claim 2 wherein said waste material is heated intermittently in said waste receptacle to prevent said waste material from accumulating in a mound-like fashion.

4. The method according to claim 1 wherein said beating of said waste material in said waste receptacle is performed on an intermittent basis.

5. The method according to claim 1 wherein said dispensing step further comprises dispensing a build material to form said three-dimensional object and a support material to form support for said three-dimensional object, said build and support materials being held in separate containers.

6. The method according to claim 5 wherein said producing step produces waste material from both build material and support materials.

7. The method according to claim 5 further comprising:
delivering at least one container to a queue station, the container holding a discrete amount of said build material; and
removing said discrete amount of said build material from said container for delivery to said dispensing device.

8. A material feed and waste system for a solid freeform fabrication apparatus, the system comprising:
means for delivering at least one container to a queue station, the container holding a discrete amount of at least one material;
removing said discrete amount of material from said container for delivery to said dispensing device,
means for delivering said discrete amount of material to at least one dispensing device;
means for dispensing said discrete amount of material by said dispensing device in a layerwise fashion to form via a plurality of layers a three-dimensional object;
means for normalizing the layers of the three-dimensional object wherein waste material is produced;
means for depositing said waste material in a waste receptacle, wherein said means for depositing said waste material comprises:
a) means for flowing said waste material through a heated line to a heated nozzle;
b) means for releasing said waste material from said heated nozzle to said waste receptacle; and
c) means for heating said waste material in said receptacle until a three-dimensional object is formed.

9. The system according to claim 8 further comprising the means for heating said waste material after said waste material is delivered to said waste receptacle being an IR heater.

10. The system according to claim 9 further comprising means for curing said waste material by exposure to actinic radiation or thermal energy.

11. The system according to claim 8 further comprising means for delivering at least one container to a queue station, the container holding a discrete amount of at least said build material; and
means for removing said discrete amount of at least said build material from said container.

12. A solid freeform fabrication apparatus for forming a three-dimensional object in a layerwise fashion by dispensing at least one material, the apparatus comprising:
a build environment having a build platform for supporting the three-dimensional object while it is being formed;
at least one dispensing device adjacent said build platform for dispensing said material to form layers of the three-dimensional object;
a motion means for respectively moving said dispensing device and said build platform with respect to each other;
means for normalizing the layers of said dispensed material thereby producing waste material;
a computer controller for receiving object data descriptive of the three-dimensional object and for processing the data and controlling the apparatus when forming the three-dimensional object; and
a material delivery and waste removal means for receiving and delivering said at least one material to said dispensing device and depositing said waste material in a waste receptacle, wherein said waste removal means includes means for depositing said waste material comprising:
means for flowing said waste material through a heated line to a heated nozzle;
means for releasing said waste material from said heated nozzle to said waste receptacle; and
means for heating said waste material in said waste receptacle until a three-dimensional object is formed.

13. The material and waste removal means according to claim 12 further comprising:
a. means for receiving at least one container, the container holding a discrete amount of said at least one material; and
b. means for removing said discrete amount of said at least one material from the container.

14. The apparatus according to claim 13 further comprising means for ejecting said container when substantially all of the material in the container have been removed.

15. The apparatus according to claim 12 further comprising a waste curing means for curing said waste material after said waste material is deposited in said waste receptacle, said waste material being cured by exposure to actinic radiation or thermal energy.

16. The apparatus according to claim 12 wherein said dispensing device dispenses a build material to form the three-dimensional object and a support material for forming support for the three-dimensional object.

17. The apparatus according to claim 12 having two dispensing devices, one dispensing device dispensing a build material to form the three-dimensional object, and the other dispensing device dispensing a support material to form support for the three-dimensional object.

18. The apparatus according to claim 12 further comprising an IR heater to heat said waste material after it is delivered to said waste receptacle.
